(19) United States
(12) Patent Application Publication
(10) Pub. No.: US 2026/0079930 A1
(43) Pub. Date: Mar. 19, 2026

(54) FIELD SERVICE RECORD SEARCH USING GENERATIVE AI

(71) Applicant: Salesforce, Inc., San Francisco, CA (US)

(72) Inventors: Puneet DHALIWAL, Dublin, CA (US); Shreyaa SRIDHAR, Belmont, CA (US); Nafeez Salma Chittoor KHADER, Fremont, CA (US); Rajan SHAH, Yardley, PA (US); Niv GARBER, Degania Bet (IL); William CARPENTER, Brooklyn, NY (US); Sindhusree AITA, Sunnyvale, CA (US); Man Kit YAU, Burnaby (CA)

(73) Assignee: Salesforce, Inc., San Francisco, CA (US)

(21) Appl. No.: 19/019,274

(22) Filed: Jan. 13, 2025

Related U.S. Application Data
(60) Provisional application No. 63/695,231, filed on Sep. 16, 2024.

(51) Int. Cl. G06F 16/242; G06N 3/0475

(52) U.S. Cl. CPC G06F 16/2445; G06N 3/0475

(57) ABSTRACT

Methods, systems, and machine-readable media perform a search of field service records in a datastore using generative artificial intelligence (AI). An utterance requesting a search of field service records is received from a user device. The generative AI selects one or more actions with which to process the user utterance. The generative AI also resolves a datetime range. A field service record data query language (DQL) query is built based on the selected one or more actions and the datetime range. The DQL query is executed on a field service record datastore to receive a list of field service records, which are then transmitted to the user device responsive to the utterance. The generative AI can also be used to format the field service records for display before transmitting to the user device. Generative AI hallucinations and inaccuracies are avoided in the search results.

### CROSS-REFERENCE TO RELATED APPLICATION

This application claims the benefit of U.S. provisional patent application No. 63/695,231, filed Sep. 16, 2024, which is incorporated herein by reference in its entirety.

### TECHNICAL FIELD

One or more implementations relate to the fields of systems that combine database systems and generative artificial intelligence systems; and more specifically, to field service record search query resolution using generative artificial intelligence (AI).

### BACKGROUND ART

A field service technician may travel to a site of work to be performed, where the site and the exact nature of the work may be unfamiliar to the field service technician. Such work can include site evaluation work (e.g., for quote, bid, or insurance purposes), sales or customer service work, site premises construction or maintenance, installation or repair of indoor or outdoor appliance, fixture, or utility systems, information technology (IT) infrastructure work, energy generation or transmission infrastructure work, or landscaping, groundskeeping, or janitorial work, as but a few examples. A field service technician can be an agent of a private organization or a governmental entity. In some instances, a field service technician may be dispatched to perform ordered work by a dispatcher. A field service technician may make use of mobile information technology devices in the course of performing field work.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 is a block diagram illustrating a field service data record query environment according to some example implementations.

FIG. 2 is a more detailed block diagram illustrating a field service data record query service according to some example implementations.

FIG. 3 is a block diagram illustrating a system for field service data record query using generative AI according to some example implementations.

FIG. 4 is a block diagram illustrating an example work order object.

FIG. 5 is a block diagram illustrating an example work order line item object.

FIG. 6 is a block diagram illustrating an example service appointment object.

FIG. 7 is a user interface diagram illustrating an example generative AI input prompt template builder user interface.

FIG. 8 is a flow diagram illustrating an example method of searching a datastore and returning relevant records based on a dispatcher utterance.

FIG. 9 is a flow diagram illustrating an example method of searching a datastore and returning relevant records based on a field service technician utterance.

FIG. 10 is a flow diagram illustrating an example method of building, verifying, and saving a generative AI input prompt template.

FIG. 11 is a flow diagram illustrating an example method of field service record search using generative AI.

FIG. 12A is a block diagram illustrating an electronic device according to some example implementations.

FIG. 12B is a block diagram of a deployment environment according to some example implementations.

### DETAILED DESCRIPTION

In preparation for performing field service work, a field service technician may query a work order datastore containing work order data to return selected work orders or schedules. As examples, a field service technician may wish to know what work the field service technician may be scheduled to perform in the upcoming day, or the upcoming week, or what work the field service technician performed the previous day, or the previous week. Similarly, a dispatcher or other scheduling supervisor may desire to know what work may be scheduled, in the present, future, or past, for a particular field service technician or team of field service technicians. Records, such as work order records, containing the desired information may be stored in a datastore (e.g., database or data lake) or other data system. However, querying the datastore or other data system using conventional query methods to obtain the desired information may involve technical skill that is outside of the area of expertise of the field service technician, dispatcher, or supervisor. For example, the datastore or other data system may be configured to be queried using a specialized data query language (DQL), such as Structured Query Language (SQL) or Salesforce Object Query Language (SOQL). A technician, dispatcher, or other supervisor seeking work order or service information may find writing query language queries in the specialized DQL to be a time-consuming and difficult process, outside the scope of expertise of the information-seeker.

Accordingly, the following description describes implementations for improving generation and execution of DQL queries of field service data stored in one or more datastores using tools of generative AI, such as one or more large language models (LLMs). The example implementations described herein permit a field service worker or dispatcher to quickly and conveniently query the data stores using natural language inputs, sometimes referred to as utterances, with no special knowledge of a specialized DQL. The generative AI can generate outputs, including (a) selections from among choices presented as context data or from among choices already known to the generative AI, (b) resolved variables that may be used to generate DQL queries, and/or (c) DQL queries themselves, based on input prompts. The implementations described herein can resolve information not literally specified in a natural-language query but determinable from context, can generate DQL queries based on the resolved information, and return useful datastore query results for information-seeker, within seconds, without human DQL query-writing effort.

As an example, example implementations described herein can resolve, from a natural language query (e.g., as derived from a spoken user utterance), (a) the type of data record or object being searched for, (b) a desired date range, and (c) the identity of a person who should be specified in a data query, which may in some cases be the information-seeker. The example implementations can then use this resolved information to generate an appropriate DQL query, which can then be executed against a datastore to return the information being sought. A generative AI can be used to play a role in the information resolution. In some example implementations, a generative AI can further play a role in formatting the returned datastore results, generated through use of the query, for display to an end user, such as a field service worker or dispatcher, via a user interface of a device of the end user. Example input utterances can include phrases like “Show me my service appointments for the next week” (for a field service technician) or “Give me Tom's work order line items for the week starting two Mondays from now” (for a dispatcher or other supervisor of a field service technician Tom).

### Multi-Tenant Environment

A multi-tenant system can be configured to serve multiple organizations, each as a tenant on the system. The system can include multiple information technology infrastructure clusters, known as a points of deployment (“pods”), configured to provide redundancy, load balancing, and high availability. Each pod can include hardware servers, software, and networking equipment collocated within a geographical area, and can host multiple organizations. The software can include, as examples, an application server, database server, a database, a file system, and a search system. In implementations as described herein, the software can further include a generative AI gateway, such as an LLM gateway, configured to provide prompt inputs to a generative AI model, such as an LLM. The prompts can be textual or can be of other modalities, such as image prompts, audio prompts, or video prompts. The LLM or other generative AI can be hosted by the multi-tenant system, e.g., on one of its pods, or can be hosted outside of the system and accessed via the internet. The generative AI gateway can be configured to interface with one or more different generative AI models, abstracting away the differences in inputs expected by the different models and the outputs provided by the different models back to the system. Each pod can host one or more environments for each tenant on the pod. The environments can include, as examples, one or more of a production or “live” environment, a development environment, a testing environment, an integration environment, and a training environment.

One or more tenant users of each environment may be designated as organization administrators (“admins”), bestowing administrative privileges them within the respective environment running on the pod. Other tenant users may be designated with other permissions levels, for example, as dispatchers or field service workers. Admins can be authorized, via their permissions levels, to configure different generative AI prompt templates for different scenarios.

### Field Service Data Record Query Service and Environment

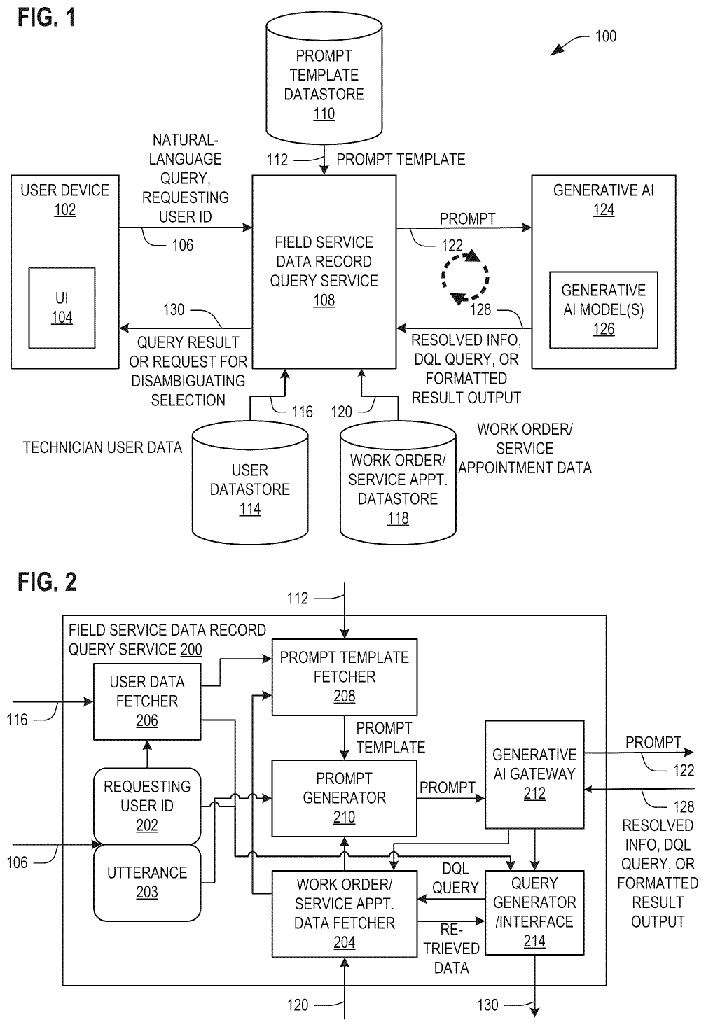

FIG. 1 illustrates an example field service data record query environment 100, including a user device 102 and a field service data record query service 108. Environment 100 can, in some examples, operate within the context of a multi-tenant system or environment as described above, and as described in greater detail below. The user device 102 can be any computing device configured to provide a user interface (UI) 104 and configured with communication capabilities to communicate with other computing devices. As examples, the user device 102 can be a personal computer or mobile device such as a smartphone, tablet, or smart watch. The user device 102 can beneficially be a mobile device, providing the advantage that it can be used by a field service worker while on assignment (or between assignments) in the field. The user device 102 can be configured to allow a user to input a natural-language query, which is sometimes referred to as a user utterance. The utterance can, for example, be representative of a field service data record search request. The initial utterance may be processed by the field service data record query service 108, and in some cases this processing can be informed by one or more follow-up utterances, which can also be provided from the user device 102 via connection 106.

The utterance can, in some examples, originate as audio data representing an oral/verbal input provided to the user device 102 via a microphone of or connected to the user device 102 and subsequently transcribed to textual data. For example, deep-learning-based speech-to-text transcription model (not shown) can be used to transcribe the utterance. The deep-learning-based speech-to-text transcription model can be hosted on the user device 102 itself, or can be hosted on another computing device (not shown), e.g., on the cloud, and accessed by the user device 102 via the internet. The user device 102 can provide the transcription model with the audio data and the transcription model can return a transcription of the utterance as textual data to the user device 102. In some examples, the user device 102 can be configured with specialized hardware circuitry capable of performing speech-to-text transcriptions. In some examples, the utterance remains as audio data and is not transcribed to textual data before being transmitted to field service data record query service 108. In some examples, the utterance originates as textual data. For example, the user device 102 can include a keyboard (e.g., an on-screen keyboard) or other input arrangement by which the utterance can be entered and/or edited by typing.

The user device 102 can transmit the utterance via connection 106 to the field service data record query service 108. A user identifier (user ID) of the user making the field service data record search request can also be provided to the field service data record query service 108 along with the utterance. The field service data record query service 108 can, for example, comprise software running on one or more computing devices other than the user device 102, e.g., in the cloud. In such examples, connection 106 may be via the internet or an intranet, and may include various intermediary network infrastructure devices and connections. In some examples, the field service data record query service 108 may run at least in part on the user device 102. The field service data record query service 108 can be configured to return to the user interface 104 of the user device 102 an output comprising requested records based on the input user utterance. The field service data record query service 108 may therefore connect to one or more datastores to retrieve relevant records requested in the user utterance. As examples, the field service data record query service 108 can connect to user datastore 114 via connection 116 to retrieve field service technician user data, and to work order/service appointment datastore 118 via connection 120 to retrieve work order and service appointment data. For example, the field service technician user data can comprise data representative of (e.g., used to populate the attribute values of) user objects. For example, the work order and service appointment data can comprise data representative of (e.g., used to populate the attribute values of) work order objects, work order line item objects, and/or service appointment objects.

The field service data record query service 108 can be configured to generate search results of data (e.g., the work order and service appointment data from work order and service appointment datastore 118) based at least in part on the user utterance and based at least in part on output of a generative AI 124. The field service data record query service 108 can create a prompt that can be based on a prompt template and can send the created prompt as input to the generative AI 124 via connection 122. The field service data record query service 108 may therefore connect to one or more datastores to retrieve relevant generative AI prompt templates that may be used to create generative AI prompts. A generative AI prompt template can comprise a drafted generative AI prompt having certain variable placeholders, sometimes referred to as merge fields, that can subsequently be filled to create a prompt in a process referred to as hydration. As an example, the field service data record query service 108 can connect to prompt template datastore 110 via connection 112 to retrieve an appropriate AI prompt template. Connections 112, 116, and 120 are illustrated as unidirectional in FIG. 1 for the sake of simplicity, but can be bidirectional. Field service data record query service 108 can, for example, transmit DQL queries to datastores 110, 114, 118 via connections 112, 116, 120.

In some examples, the generative AI 124 may be executed using the same one or more computing devices used to execute the field service data record query service 108, in which case the prompt can be transmitted from the field service data record query service 108 to the generative AI 124 without a network as an intermediary. In other examples, the generative AI 124 is provided on one or more separate computer systems from the one or more computer systems used to run the field service data record query service 108, and AI input and output connections 122, 128 may be via the internet, for example. For example, the generative AI 124 may be provided as a cloud service. Examples of the generative AI 124 include Google Gemini 1.5 Pro, OpenAI GPT-4 or GPT-40, and Anthropic Claude 3.5. GPT-4 is based on eight models with 220 billion parameters each, for a total of about 1.76 trillion parameters, connected by a mixture of experts (MoE). GPT-40 has a token limit of 128,000 tokens. Gemini 1.5 Pro has 1.5 trillion parameters and a token limit of 1,000,000 tokens. A token limit may dictate the combined size of both an input (including prompt and context data) and an output of the generative AI 124.

The generative AI 124 can include one or more generative AI models 126. Where more than one generative AI model 126 is used, the models can each accomplish different AI functions and/or can work in concert with each other to produce generative AI outputs. For example, one or more of the models 126 can comprise an LLM. The form of the generative AI outputs can be of any modality, e.g., textual data, audio data, video data, pictorial data, audiovisual data, code data, or interactive or game data, as examples. In some examples, the generative AI 124 can be trained on the work order and service appointment data from work order and service appointment datastore 118, such that the model 126 knows and understands this data, and is capable of directly generating search results of the work order and service appointment data. The generative AI 124 can therefore return search results directly to field service data record query service 108 via connection 128. In other examples, the generative AI 124 is not trained on the work order and service appointment data from work order and service appointment datastore 118, but can be provided this data as context data via connection 122. In such examples, generative AI model 126 is again capable of directly generating search results of the work order and service appointment data. The generative AI 124 can therefore return search results directly to field service data record query service 108 via connection 128, which can subsequently be returned to user device 102 via connection 130.

In other examples, however, the generative AI 124 is not trained on the work order and service appointment data from work order and service appointment datastore 118 and cannot be provided this data as context data. For example, the generative AI 124 may be trained and provided (e.g., as a service) by a third party, and data security and confidentiality concerns, and/or the rapidly changing nature of the work order and service appointment data, may make it undesirable or impracticable for the generative AI 124 to be trained on the work order and service appointment data. Also for example, the size of the work order and service appointment data may exceed the context window limitations of the generative AI 124. In these instances, the generative AI 124 may not be configured to directly provide search results of the work order and service appointment data.

Accordingly, in some examples, generative AI 124 may be instructed by the input prompt from the field service data record query service 108 to generate a DQL query based on the user utterance. The AI-generated DQL query can be returned to the field service data record query service 108, and the field service data record query service 108 can be configured to then query the work order/service appointment datastore 118 using the AI-generated DQL query. The field service data record query service 108 can then send the results of the DQL query to the user device via connection 130, or the results can first be formatted (e.g., using generative AI 124) before transmitting the formatted results to the user device 102 via connection 130. To format the results using the generative AI 124, the field service data record query service can select an appropriate prompt template from the prompt template datastore 110, create a prompt based on the prompt template, and provide the prompt and the DQL query result to the generative AI 124 via connection 122. The generative AI 124 can thus format the results in accordance with instructions in the prompt. In other examples, the field service data record query service can use rules to format the DQL query result data, without calling on the generative AI 124 to perform the formatting.

In some examples, however, the generative AI may not be capable of accurately generating useful DQL queries that, when executed against the work order and service appointment datastore 118, return desired results. For example, the generative AI 124 may not be adequately trained on the particular DQL used to query the work order and service appointment datastore 118. For example, the particular DQL may have had language revisions since the generative AI 124 was trained. Moreover, generative AI models may have tendencies to output hallucinations and other inaccuracies that may be critical when writing DQL queries. If an AI-generated DQL query is not well-formed according to the language rules of the particular DQL, the query will return an error when executed, as may occur when an AI-generated DQL query does not fully understand the DQL itself or the structure of the datastore being queried, for example, the names of the data fields in the datastore. In some examples, therefore, the field service data record query service 108 can be configured not to rely on AI-generated DQL queries to query work order and service appointment datastore 118, and may instead be configured to generate a DQL query, with which to query the work order and service appointment datastore 118, based on rules. As described below, however, the generative AI 124 may nevertheless play a role in selecting the rules and in resolving variable values that may go into the DQL query in accordance with the selected rules.

Accordingly, in some example implementations of environment 100, the generative AI 124 may be used to select a ruleset by which a DQL query is generated. The field service data record query service 108 can be configured to select an appropriate prompt template from the prompt template datastore 110 and to generate a prompt based on the selected prompt template. The prompt, which can include the user utterance (e.g., a textual transcription of an oral/verbal utterance), can be transmitted to the generative AI 124 via connection 122 to instruct the generative AI 124 to pick a ruleset from among a list of rulesets, that, based on the utterance, is most likely to generate the DQL query needed to return the information requested in the utterance. The list of rulesets and natural-language descriptions thereof can be provided to the generative AI 124 as context data that is delivered the generative AI 124 along with or as part of the prompt. The AI can be instructed in the prompt to pick only from among the listed rulesets.

As one example, the generative AI 124 may determine from an utterance that includes the words “work orders” or substantially similar language that a ruleset designed to create a DQL query that returns work order data is desirable and should be selected. As another example, the generative AI 124 may determine from an utterance that includes the words “work order line items,” or “tasks,” or “things I need to do,” or substantially similar language, that a ruleset designed to create a DQL query that returns work order line item data is desirable and should be selected. As yet another example, the generative AI 124 may determine from an utterance that includes the words “service appoints,” or “appointments,” or “service calls,” or substantially similar language, that a ruleset designed to create a DQL query that returns service appointment data is desirable and should be selected.

Each ruleset can function to create a well-formed, syntactically correct DQL query that executes without error, even if the input utterance is ungrammatical or of an unanticipated form. For example, each ruleset can comprise a DQL query template containing DQL words, phrases, and commands with variables that can be filled in with the relevant values used to limit the resultant query. The ability of the generative AI 124 to flexibly understand a wide variety of natural-language inputs that would not be understood by a DQL parser or interpreter can thus be leveraged by the field service data record query service 108 to query records in a datastore while highly mitigating or eliminating altogether any risk of AI hallucinations or inaccuracies infecting the DQL query and rendering it inoperative. The rulesets can be hard-coded into the field service data record query service 108, or can be user-defined and editable and stored in another datastore (not shown) that is accessible to the field service data record query service 108.

As one example, a rule for translating a natural-language technician utterance requesting scheduled service appointments into a DQL query can provide the template “SELECT*FROM ServiceAppointment WHERE Status=‘Scheduled’ AND OwnerId={UserId} AND SchedStartTime> {StartDateTime} AND=SchedStartTime< {EndDateTime}”. After resolving and filling in the variable fields {UserId}, {StartDateTime}, and {EndDateTime}, which can be done in accordance with the methods described below, this template results in the ready-to-execute DQL query “SELECT*FROM ServiceAppointment WHERE Status=‘Scheduled’ AND OwnerId=54321 AND SchedStartTime>2024-07-09T17:08:23Z AND=SchedStartTime<2024-07-16T17:08:23Z”. In example implementations, a ruleset may result in different templates being selected and/or different DQL query forms being constructed depending on whether the entity type being requested is service appointments, work orders, or work order line items; on whether the requester is a technician or dispatcher; and/or on whether the requested records are for the past (e.g., completed or discontinued work) or the future (e.g., scheduled work).

Having selected an appropriate ruleset (e.g., using the generative AI 124), the field service data record query service 108 may be configured to further use the selected ruleset to generate a DQL query, e.g., by filling in variable values in a DQL template selected according to the ruleset. Some of the variable values may be inherent in the request provided to the field service data record query service 108. For example, based on the field service data record query service 108 recognizing that an input is issued by a field service technician, it may be understood by the field service data record query service 108 that a field service technician may only access records belonging to that same field service technician, and not those of other users. Accordingly, the user limitation variable in the created DQL query can be set to the user ID of the requesting field service technician. As another example, based on the field service data record query service 108 detecting the words “my” or “me” in the utterance, it may be understood by the field service data record query service 108 that the user limitation variable in the created DQL query should be resolved to the user ID of the requesting user.

Some of the variable values may be resolvable by a search of a datastore. For example, if a user name or a portion of a user name (e.g., a given name) of a field service technician is provided in the user utterance, e.g., from a dispatcher, the user datastore 114 may be queried on the user name or portion thereof to return the appropriate user ID to the field service data record query service 108. Based on the query returning only a single record, the user ID of that single record may be used as the appropriate user ID in the DQL query. Based on the query returning a plurality of records, a request for a disambiguating selection may be sent to the UI 104 of the user device 102 via connection 130, prompting the user who initiated the query to select between different possible user records to identify the field service technician of interest, the identified user record selected by the user can be returned to the field service data record query service 108 via connection 106, and the user ID of that identified user record may be used as the appropriate user ID in the DQL query.

Some of the variable values may be resolved through further use of the generative AI 124. For example, the user utterance may specify a date and/or time range, such as “Show me my appointments for the next hour.” As part of its DQL query creation procedure, the field service data record query service 108 can be configured to select an appropriate prompt template from the prompt template datastore 110 to prompt the generative AI 124 translate the natural-language query into cither a date literal expression or function or a specific numerical datetime range (e.g., including a numerical start datetime and a numerical end datetime). Some DQLs provide datetime literal expressions or functions that can be used directly in a DQL query to specify a date or time range without numerically specifying an exact start and/or end datetime. For example, SOQL provides support for datetime literal expressions such as YESTERDAY, TODAY, TOMORROW, LAST_WEEK, THIS_WEEK, NEXT_WEEK, LAST_MONTH, THIS_MONTH, NEXT_MONTH, LAST_N_DAYS:n, NEXT_N_DAYS:n, N_DAYS_AGO:n, NEXT_N_WEEKS:n, LAST_N_WEEKS:n, N_WEEKS_AGO:n, NEXT_N_MONTHS:n, LAST_N_MONTHS:n, among others. As supported, these defined expressions or functions can be used in a DQL query directly, and the query execution engine of the datastore can translate the datetime literal to the appropriate numerical datetime range when executing the query. Accordingly, the generative AI 124 can be provided with a list of supported datetime literals and corresponding natural-language descriptions thereof as context data and may be prompted to select the most likely useful datetime literal based on the initial user utterance. In some examples, the generative AI 124 may already be trained on the supported datetime literal expressions or functions (e.g., from having scraped online DQL documentation as part of its training data) and it will not be necessary to provide the list of datetime literal expressions or functions as context data with the prompt.

Not all DQLs support datetime literal expressions or functions such as those listed above, and even where they do, not all natural-language expressions of datetime range may be correctly resolvable to a defined datetime literal expression or function supported by the DQL. For example, while the utterance “Show me my appointments for next week” may lead a generative AI 124 to usefully select a NEXT_WEEK datetime literal expression, “Show me my appointments for the next week” may have a substantially different meaning. Whereas the NEXT_WEEK datetime literal expression may be defined to start at midnight on the first day of the week after the current week and continue for seven full days, “the next week” may be intended to mean the seven days starting from the present time rather than starting from the first day of the next calendar week. Accordingly, in some examples, the field service data record query service 108 may be configured to select a generative AI prompt template from the prompt template datastore 110 that prompts the generative AI 124 to return numerical start and end datetime values for use in a DQL query. For example, such a prompt template can be configured to generate a prompt that includes the current datetime as context data for the generative AI. Based on this supplied current datetime and the original natural-language query (user utterance), the generative AI 124 can with high reliability return the desired start and end numerical datetime values for use in the DQL query to execute against the work order and service appointment datastore 118.

Having created a suitable and syntactically correct DQL query based on the resolved record type, user ID, and datetime range values, the field service data record query service 108 can execute the DQL query against the work order and service appointment datastore 118 (or against an appropriate datastore, where the work order and service appointment datastore 118 is representative of multiple different datastores, e.g., one for work orders, one for work order line items, and one for service appointments). The returned results may comprise one or more records, or no records (an empty set) responsive to the original user utterance. The field service data record query service 108 may then provide the returned results to the UI 104 of the user device 102 via connection 130. The UI 104 may visually display the returned results. In some examples, the field service data record query service 108 may comprise one or more routines that can format the raw query result data into a more aesthetically appealing or visually useful format, e.g., a tabular format. The formatted results may, in some examples, simplify the result data, abbreviate portions of the returned data, remove redundant or non-useful portions of the result data, add separators or whitespace to the result data, sort the result data, reorder the result data, and/or add information to the result data for enhanced presentation. In other examples, the field service data record query service 108 may select an appropriate AI prompt template from the prompt template datastore 110 to create an AI prompt that incorporates the result data and instructs the generative AI 124 format the raw DQL query result output. The formatted output may then be transmitted to the UI 104 of the user device 102 via connection 130 for presentation and display to the requesting user.

FIG. 2 illustrates an example field service data record query service 200 according to some example implementations. The field service data record query service 200 of FIG. 2 can correspond, for example, to the field service data record query service 108 of FIG. 1. The field service data record query service 200 can receive a requesting user ID 202 and an utterance 203 as inputs via connection 106, e.g., from a user device 102. The field service data record query service 200 can resolve a field service technician user ID from a requesting field service technician as the requesting user ID 202 in instances where it is a field service technician who initiates the query and provides the original user utterance requesting a search of field service data. The field service data record query service 200 can further include a user data fetcher 206 that can be configured to create and execute an appropriate DQL query to search a user datastore, such as user datastore 114 in FIG. 1, via connection 116, e.g., to resolve a user name or portion thereof in an utterance 203 to a user ID. As described above, this resolution may involve a disambiguation process involving request for and receipt of disambiguating input from a user, details of which are omitted from FIG. 2 for the sake of simplicity.

The field service data record query service 200 of FIG. 2 can further include a work order and service appointment data fetcher 204 configured to execute an appropriate DQL query to search a work order and service appointment datastore 118 via connection 120. In some examples, such a datastore 118 may comprise multiple different datastores that can be separately searched, the details of which are not illustrated in FIG. 2 for the sake of simplicity. The field service data record query service 200 can further include a query generator and interface 214 configured to generate DQL queries, receive DQL query results, and provide the results as outputs to a user device 102 via connection 130. For example, the query generator and interface 214 can be configured to generate a DQL query based on rules and/or one or more DQL query templates (not shown in FIG. 2). For example, the generated DQL query can be provided to the work order and service appointment data fetcher 204 for execution against the work order and service appointment datastore 118 to return requested data, e.g., work order data, work order line item data, and/or service appointment data.

The field service data record query service 200 of FIG. 2 can further include a prompt template fetcher 208 configured to generate and execute an appropriate DQL query to fetch an AI prompt template from prompt template datastore 110 via connection 112. The field service data record query service 200 of FIG. 2 can further include a prompt generator 210 configured to generate a generative AI prompt by filling in (“hydrating”) variable placeholders (merge fields) in a prompt template with data values and packaging context data. A retrieved prompt template can be provided from the prompt template fetcher 208 to the prompt generator 210 for this purpose. The prompt generator 210 can be configured to convert a prompt template provided by the prompt template fetcher 208 into a prompt based on data provided by the user data fetcher 206 and/or the field service technician user ID 202 of the requesting user, the work order service appointment data fetcher 204, and/or from a generative AI, such as generative AI 124 in FIG. 1, via connection 128, as described below.

The field service data record query service 200 of FIG. 2 can further include a generative AI gateway 212 (e.g., an LLM gateway). The generative AI gateway 212 can include one or more application programming interfaces (APIs) for one or more respective generative Als, thus abstracting away implementation details for the different generative Als from the perspective of the rest of the field service data record query service 200. The generative AI gateway 212 can integrate with different generative AI models and providers, exposing them as, in effect, a unified API from the perspective of any application that may use a generative AI. The use of the generative AI gateway 212 advantageously permits easier and more seamless swapping-out of one generative AI for another as the generative AI to be used by the field service data record query service 200. In addition to offering this horizontal scalability, the generative AI gateway can include a trust layer that can perform masking of personally identifiable information (PII masking), payment card information (PCI masking), and protected health information (PHI masking) that may be provided in a generative AI prompt before that information is transmitted to a third-party generative AI, thus preventing security leaks of sensitive information. Still further, the generative AI gateway 212 can handle transformation of a prompt as a normalized payload into a vendor-specific request payload. Still further, the generative AI gateway can transmit the request payload using the appropriate security credentials, which may be specific to the generative AI selected to be used, the user or user organization, or both. In some examples, the generative AI gateway 212 is provided as a separate service, e.g., a micro-service, e.g., a cloud-based service.

Having performed its various functions as described above, which may vary in different implementations, the generative AI gateway 212 can transmit a prompt via connection 122 as an input to a selected generative AI and can receive, in return, an output of the selected generative AI via connection 128. Because the generative AI may be used for different purposes by the field service data record query service 200, this generative AI output may take different forms, such as a DQL query, resolved information used to create a DQL query, or a presentation-ready formatting of a raw DQL query result.

The query generator and interface 214 can generate a DQL query based on the requesting user ID 202 and/or user ID information from the user data fetcher 206, and/or information from the generative AI gateway 212. For example, the generative AI gateway 212 can supply a selection of a particular DQL query ruleset or DQL query template that can be used by the query generator and interface 214 to create a DQL query appropriate to the utterance 203. For example, the DQL query ruleset or DQL query template can ensure a search of the appropriate type of record (the appropriate entity type), e.g., from among one or more of work orders, work order line items, or service appointments. As another example, the DQL query ruleset or DQL query template can ensure that the search is targeted to one or the other of pending scheduled (future) items or previously performed or canceled (past) items. As another example, the generative AI gateway 212 can supply a datetime literal expression or function, or precise numerical values specifying a datetime range limiting the records that should be returned as a result of the DQL query. In some examples, a generative AI can be employed to generate a DQL query directly, in which case the work order and service appointment data fetcher 204 can receive the DQL query from the generative AI gateway 212.

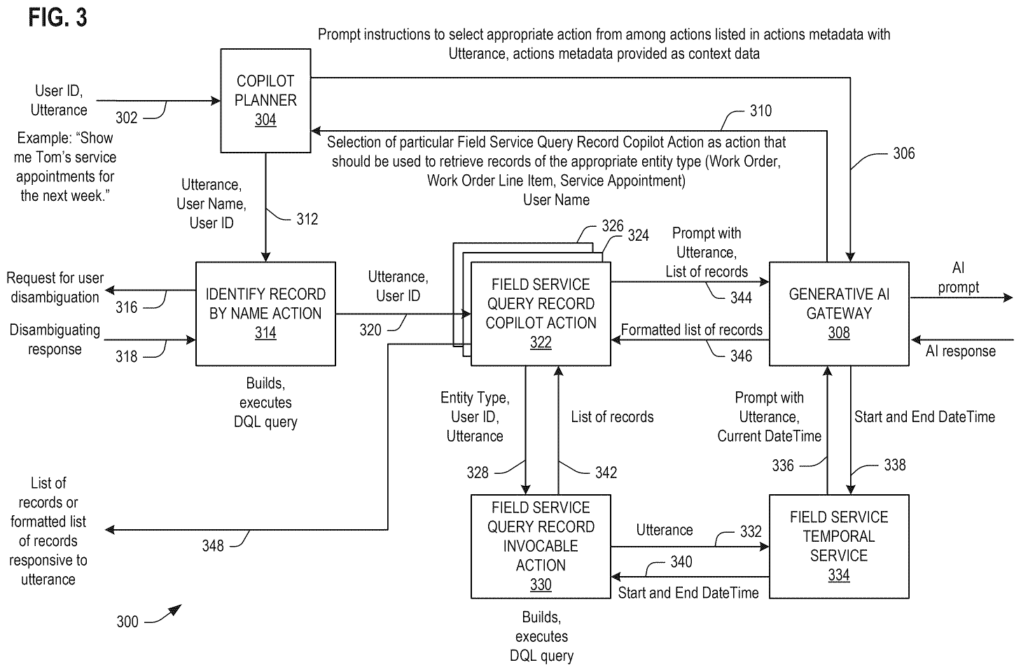

FIG. 3 illustrates a system 300 for field service data record query using generative AI according to some example implementations. System 300 can, for example, be an implementation of field service data record query service 108 in FIG. 1. For example, system 300 can operate in the context of a multi-tenant system as described above and as described in greater detail below. In example system 300, an input 302 can include an initial user utterance and a user ID of the user providing the utterance. This input 302 is provided to a copilot, which, in the context of the multi-tenant system, is an AI-driven assistant feature configured to assist users in various tasks. A Copilot Planner 304 of the copilot parses or otherwise understands the utterance to develop a plan for processing the utterance, the plan comprising a chain of one or more available actions. In the context of the multi-tenant system, actions are performed by execution of software functions or methods, and can be chained together such that an output of one action in a plan can feed into an input of a subsequent action in the plan.

In the illustrated system 300, the Copilot Planner 304 can use a generative AI understand the input utterance provided at input 302 and develop the plan of actions. The Copilot Planner 304 can select a prompt template (e.g., from a prompt template datastore, such as prompt template datastore 110 shown in FIG. 1) and can hydrate the prompt template with the utterance, e.g., with the text of the utterance. The Copilot Planner 304 can also provide a list of names of available actions and corresponding descriptions as context data. In examples, among the list of available actions, the following actions listed in Table 1 can be provided as context data:

TABLE 1
Actions Metadata

| Example action | |
|---|---|
| name | Example action description |
| Identify Record | Searches for records by name and returns a list of matching record IDs. |
| By Name | If an input for a search of user records includes “Tom” and multiple |
| | records include “Tom” in the name field, the action can return the user |
| | IDs of all users named “Tom”. |
| Field Service | Searches for work order records by building and executing a query |
| Query Record | according to a user ID and a datetime range based on a user utterance. If |
| Copilot - Work | the requesting user is a field service technician, the user ID is the user ID |
| Order | of the requesting field service technician. Otherwise, can be chained |
| | with the Identify Record By Name action to determine the user ID from |
| | a complete or partial user name given in the user utterance. |
| Field Service | Searches for work order line item records by building and executing a |
| Query Record | query according to a user ID and a datetime range based on a user |
| Copilot - Work | utterance. If the requesting user is a field service technician, the user ID |
| Order Line Item | is the user ID of the requesting field service technician. Otherwise, can |
| | be chained with the Identify Record By Name action to determine the |
| | user ID from a complete or partial user name given in the user utterance. |
| Field Service | Searches for service appointment records by building and executing a |
| Query Record | query according to a user ID and a datetime range based on a user |
| Copilot - Service | utterance. If the requesting user is a field service technician, the user ID |
| Appointment | is the user ID of the requesting field service technician. Otherwise, can |
| | be chained with the Identify Record By Name action to determine the |
| | user ID from a complete or partial user name given in the user utterance. |
| Field Service | Builds and executes a query of a given entity type, such as a work order, |
| Query Record | a work order line item, or a service appointment. The query is based on |
| Invocable Action | a user ID and a user utterance. A datetime range can be determined |
| | from the user utterance. |

In some examples, not all actions available in the multi-tenant system need to be provided as context data with the prompt, because the generative AI may have been trained on available actions and their descriptions from documentation made publicly available on the World Wide Web. The prompt template can further include instructions to select one or more appropriate actions from among actions listed in the actions metadata provided as context data or otherwise known to the generative AI.

At connection 306, the prompt, including the actions selection instructions, utterance, and actions metadata, can be sent to the generative AI gateway 308, which can function as described above with regard to generative AI gateway 212 in FIG. 2. The generative AI gateway 308 can be configured to process the prompt as described above and transmit the prompt to a generative AI, such as generative AI 124 in FIG. 1. The generative AI can process the AI prompt and understand from the prompt and the user utterance provided therein that it should select one or more appropriate actions. For example, the generative AI can understand, based on the prompt, that that generative AI should select and return a particular Field Service Query Record Copilot action. The generative AI may further understand, based on the prompt, that the generative AI should identify a user named or partially named in the utterance and that the Identify Record By Name action should be chained with the selected Field Service Query Record Copilot action. In some examples, the one or more actions selected by the generative AI to process the utterance can be from among a list of actions in actions metadata provided to the generative AI as context data along with (or as part of) the prompt. The actions metadata can include, for example, a list of actions and corresponding descriptions of the actions. In other examples, the selection of one or more actions by the generative AI is not based (or is not solely based) on actions metadata, and is instead (or additionally) based on knowledge of generative AI of available actions as may have been obtained during training of the generative AI. For example, the corpus of documents provided to the generative AI as training data during training of the generative AI can include documentation text and/or discussion text describing or discussing available actions. Accordingly, the generative AI may be aware of actions from which it may select without being provided any actions metadata.

The generative AI gateway 308 can subsequently receive a corresponding AI response from the generative AI, and, at connection 310, can transmit this response to the Copilot Planner 304. The response transmitted at connection 310 can include a selection of the particular Field Service Query Record Copilot action as an action that should be used to retrieve records of the appropriate entity type (e.g., Work Order, Work Order Line Item, or Service Appointment). The response transmitted at connection 310 can also include a user name (full or partial) extracted from the user utterance.

Having received the response from the generative AI gateway 308 via connection 310, the Copilot Planner 304 can assemble a plan (sequence of one or more actions) for acting on the input utterance by chaining one or more selected actions recommended in the response transmitted at connection 310. For example, based on a determination by the generative AI, based on the user utterance, that a user ID resolution will be necessary, the Copilot Planner 304 can chain the Identify Record By Name action 314 in the plan. Alternatively, based on a determination that a user ID resolution will not be necessary (e.g., because the user ID of the requesting user is that of a field service technician, or because no full or partial user name was given in the utterance), the Copilot Planner 304 can omit the Identify Record By Name action 314 from the plan and can use the user ID of the requesting user as the user ID to limit the record request. Further, based on a determination by the generative AI, the Copilot Planner 304 can include a selected Field Service Query Record Copilot action in the plan, such as one or more of Field Service Query Record Copilot-Work Order action 322, Field Service Query Record Copilot-Work Order Line Item action 324, or Field Service Query Record Copilot-Service Appointment action 326. Further, based on a determination by the generative AI, the Copilot Planner 304 can include Field Service Query Record invocable action 330 in the plan.

Having built the plan as a chain of actions, the plan can be executed by executing each of the actions in the plan in the sequence established by the plan. In the example illustrated in FIG. 3, the Identify Record By Name action 314 can be provided with inputs 312 including the utterance, the user name as extracted from the utterance by the generative AI, and/or the user ID of the requesting user. The Identify Record By Name action 314 can build and execute a DQL query (e.g., a SOQL query) to search a user datastore (e.g., user datastore 114 in FIG. 1) for user records having the input user name. The DQL query can, in some examples, limit the search to only field service technician user records based on the plan. Based on more than one record being returned, a request for user disambiguation 316 can be output to the user device of the requesting user (e.g., user device 102 in FIG. 1), and a disambiguating response 318 from the user can be received to narrow the multiple returned user records to a single particular user record. As an example, the request for user disambiguation 316 can include text such as “Here are all the Toms I found. Which one are you referring to?” This text would then be followed by a list of user records, e.g., field service technician user records. The user interface of the user device could allow the user to select a given one of the listed field service technician user records. Based on only a single user record being return or based on the multiple returned user records having been narrowed to a single user record by the disambiguating response 318 from the user, the Identify Record By Name action 314 can thus resolve the user name in the input 312 to a single user ID. In examples in which the user ID is implied as that of the requesting field service technician, the Identify Record By Name action 314 can be omitted from the plan. In such examples, the user need not enter a user ID as an input because it is understood to the system 300 as a consequence of the user having logged in and having been authenticated under the user's own account for the system 300, e.g., the multi-tenant system.

Having established a single user ID (e.g., by having resolved the user name in input 312 to a single user ID), the actions chain can be proceed to a selected Field Service Query Record Copilot action 322, 324, or 326. Although Table 1 lists, and FIG. 3 illustrates, three such actions 322, 324, 326, in some example implementations, there may be more or fewer such actions. For example, in some example implementations, there may be only one Field Service Query Record Copilot action configured to handling queries of multiple different entity types (e.g., work orders, work order line items, and service appointments). In Table 1 and the example illustrated in FIG. 3, a different Field Service Query Record Copilot action is provided for each of these three different entity types. The illustrated example has the benefit that the entity type is resolved by generative AI at the planning stage, as transmitted at connection 310 in FIG. 3, and no further resolution of entity type is necessary by the Field Service Query Record Copilot action. In examples in which only one Field Service Query Record Copilot action is provided to handle all entity types, the sole Field Service Query Record Copilot action could be configured to make another call to the generative AI, e.g., via generative AI gateway 308, to make the entity type resolution, and/or could include logic configured to make the entity type resolution.

At connection 320, the Identify Record By Name action 314 can transmit the utterance and the user ID to the selected Field Service Query Record Copilot action 322, 324, or 326. The selected Field Service Query Record Copilot action 322, 324, or 326 can provide the resolved entity type, the resolved user ID, and the initial user utterance as input 328 to a Field Service Query Record invocable action 330 chained in the plan created by Copilot Planner 304 with instructions to retrieve a list of records associated with the resolved entity type and the resolved user ID. Before retrieving the records, the Field Service Query Record invocable action 330 can be configured to check whether the initial user utterance calls for limiting the retrieved list to a particular timeframe. The Field Service Query Record invocable action 330 can therefore provide the initial user utterance as input 332 to a Field Service Temporal Service 334. The Field Service Temporal Service 334 is configured to select an appropriate generative AI prompt template (e.g., from prompt template datastore 110), create a prompt by hydrating the prompt template with the initial user utterance and the current datetime, and provide the hydrated prompt as input 336 to the generative AI gateway 308. The selected prompt template includes instructions to determine a datetime range (e.g., start datetime and end datetime) based on the initial user utterance and the current datetime given as context data. The generative AI gateway 308 can perform its various functions as described above before providing the AI prompt to a selected generative AI, which returns a response that includes the requested datetime range (e.g., start datetime and end datetime). In some examples, the generative AI gateway can return a DQL datetime literal expression or function rather than a numerical datetime range. The generative AI response is provided by the generative AI gateway 308 as output 338 back to the Field Service Temporal Service 334. The Field Service Temporal Service 334 can parse the AI response to extract the numeral datetime range value(s) or DQL datetime literal expression or function in the AI response and return these values as its output 340 back to the Field Service Query Record Invocable Action 330. In some instances, the generative AI may determine that no datetime range limitation is specified in the initial user utterance, in which case the Field Service Temporal Service 334 will provide this understanding to the Field Service Query Record Invocable Action 330 in its output 340.

The Field Service Query Record Invocable Action 330 can now build and execute a DQL query of a datastore specified by the entity type. The Field Service Query Record Invocable Action 330 can be configured to generate a DQL query based on the resolved entity type information, the resolved user ID information, and, if any, the datetime range information provided by the Field Service Temporal Service 334. In some examples, the Field Service Query Record Invocable Action 330 can be programmed with logic or a ruleset that can build the DQL query. In some examples, the Field Service Query Record Invocable Action 330 can use a DQL query template, or select an appropriate DQL query template from among several available DQL query templates, suitable for the information given. The DQL query template(s) can be hard-coded into the Field Service Query Record invocable action 330 or can be stored in a datastore (not shown in FIG. 3) that is queried by the Field Service Query Record invocable action 330. In some examples, a generative AI can be employed to generate a DQL query directly, or to select an appropriate DQL template from among a list of such templates provided as context data to the generative AI. The Field Service Query Record Invocable Action 330 can hydrate a selected DQL query template with the resolved search information (e.g., entity type, user ID, start and end datetime) to build the DQL query.

As one example, the DQL query template used may depend on the specified entity type, e.g., there may be one or more DQL query templates used when a work order entity type is specified, another one or more DQL query templates used when a work order line item entity type is specified, and another one or more DQL query templates used when a service appointment entity type is specified. As another example, there may be one or more DQL query templates used when numerical start and end datetimes are specified, another one or more DQL query templates used when DQL datetime literal expressions or functions are specified, and another one or more DQL query templates used when no start and end datetimes are specified and no DQL datetime literal expressions or functions are specified. As yet another example, there may be one or more DQL query templates used when a specified datetime range or datetime literal expression or function is in the future (indicating that scheduled records should be searched on and returned, as thus that a data field such as SchedStartTime or StartDate may be relevant for the time limitation), and another one or more DQL query templates used when a specified datetime range or datetime literal expression or function is in the past (indicating that completed or canceled records should be searched on, and thus that a data field such as ActualEndTime or EndDate may be relevant for the time limitation).

After building a DQL query appropriate to the resolved search information (e.g., entity type, user ID, start and end datetime), the Field Service Query Record invocable action can execute the query to retrieve a list of records that can be provided as output 342 back to the Field Service Query Record Copilot action 322. The Field Service Query Record Copilot action 322 can then, in some example implementations, provide the retrieved list of records as output 348 back to the UI of the user device (e.g., UI 104 of user device 102 in FIG. 1). In some example implementations, the Field Service Query Record Copilot action 322 can first format the retrieved records before transmitting them to the user device. In some examples, the Field Service Query Record Copilot action 322 may be configured with one or more routines that can format the raw DQL query result data into a more aesthetically appealing or visually useful format, e.g., a tabular format. For example, the Field Service Query Record Copilot action 322 may add markup language tags (e.g., Hypertext Markup Language tags) to the returned results. The formatted results may, in some examples, simplify the result data, abbreviate portions of the returned data, remove redundant or non-useful portions of the result data, add separators or whitespace to the result data, sort the result data, reorder the result data, and/or add information to the result data for enhanced presentation. In other examples, the Field Service Query Record Copilot action 322 may provide the list of records and an AI prompt as input 346 to the generative AI gateway 308. The AI prompt can, for example, be based on AI prompt template selected by the Field Service Query Record Copilot Action 322, e.g., from an AI prompt template datastore, e.g., prompt template datastore 110 in FIG. 1. The AI prompt can incorporate the result data and can instruct a generative AI (e.g., generative AI 124 in FIG. 1) to format the raw DQL query result output. The formatted list of records may then be returned from the generative AI gateway 308 to the Field Service Query Record Copilot action 322 as output 346 and transmitted to the UI of the user device as output 348 for presentation and display to the requesting user.

### Field Service Data Record Objects

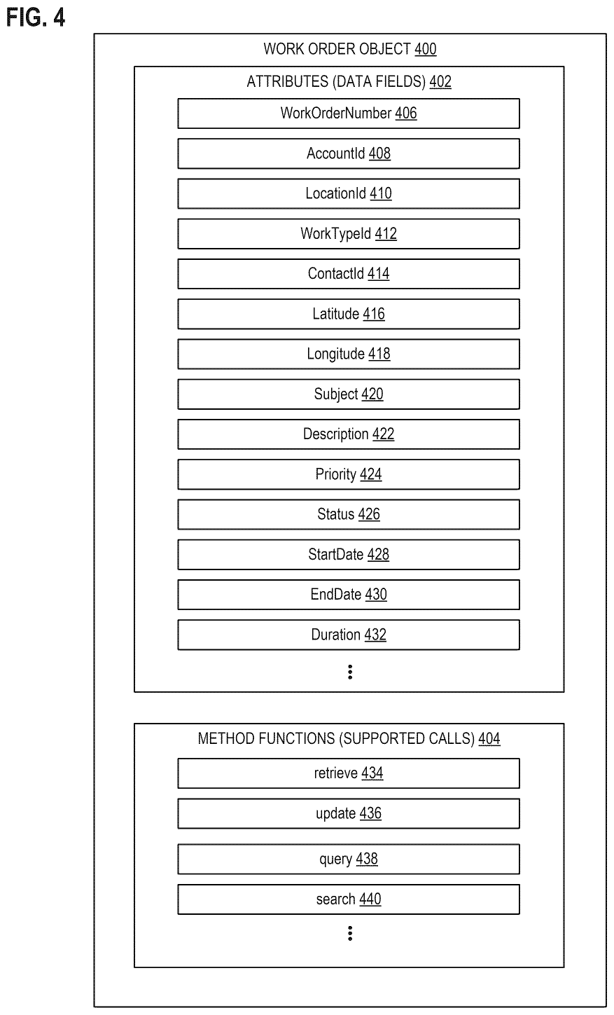

FIGS. 4 through 6 illustrate example objects, specifically, an example work order object 400, an example work order line item object 500, and an example service appointment object 600. Objects can store, as attributes, information relative to an instance of an entity type. These attributes are the data fields of the object. The data in the data fields can be stored in a datastore, such as work order and service appointment datastore 118 shown in FIG. 1. Objects can also have associated with them a number of method functions (supported calls), which are software routines associated with the object that can operate on the object's attribute data. Some of the attributes can include IDs that point to other objects that may, in turn, hold data in their own attributes particular to these other objects. In some examples, the field service record search implementations described herein can return one or more attributes of one or more of objects 400, 500, 600, and/or one or more attributes of objects pointed to by one or more of the attributes of one or more of objects 400, 500, 600, as the query result (retrieved data).

FIG. 4 illustrates an example work order object 400 that can represent field service work to be performed for a customer by one or more field service technicians. The work order object 400 can be populated with a number of attributes (data fields) 402 and can also have associated with it a number of method functions (supported calls) 404 that can operate on the attributes 402. As illustrated, the attributes 402 of the example work order object 400 can include WorkOrderNumber 406, AccountId 408, LocationId 410, WorkTypeId 412, ContactId 414, Latitude 416, Longitude 418, Subject 420, Description 422, Priority 424, Status 426, StartDate 428, EndDate 430, and Duration 432. In some examples, the work order object 400 can include one or more other attributes 402, such as Address, AssetId, Asset WarrantyId, BusinessHoursId, CaseId, City, Country, CurrencyIsoCode, Discount, DurationInMinutes, DurationType, EntitlementId, GeocodeAccuracy, GrandTotal, IsClosed, IsGeneratedFromMaintenancePlan, IsStopped, LastReferencedDate, LastViewedDate, LineItemCount, LocationId, MaintenancePlanId, Maintenance WorkRuleId, MilestoneStatus, MinimumCrewSize, OwnerId, ParentWorkOrderId, PostalCode, Pricebook2Id, ProductServiceCampaignId, ProductServiceCampaignItemId, PromptTemplateDevName, PromptTemplateId, RecommendedCrewSize, ReturnOrderId, ReturnOrderLineItemId, RootWorkOrderId, ServiceAppointmentCount, ServiceContractId, ServiceDocumentTemplate, ServiceReportLanguage, ServiceReportTemplateId, ServiceTerritoryId, SlaExitDate, SlaStartDate, State, StatusCategory, StopStartDate, Street, Subtotal, SuggestedMaintenanceDate, Tax, and/or TotalPrice. As illustrated, the method functions 404 of the example work order object 400 can include retrieve 434, update 436, query 438, and search 440. In some examples, the work order object can include one or more other method functions 404, such as create, delete, describeLayout, describeSObjects, getDeleted, getUpdated, undelete, and/or upsert.

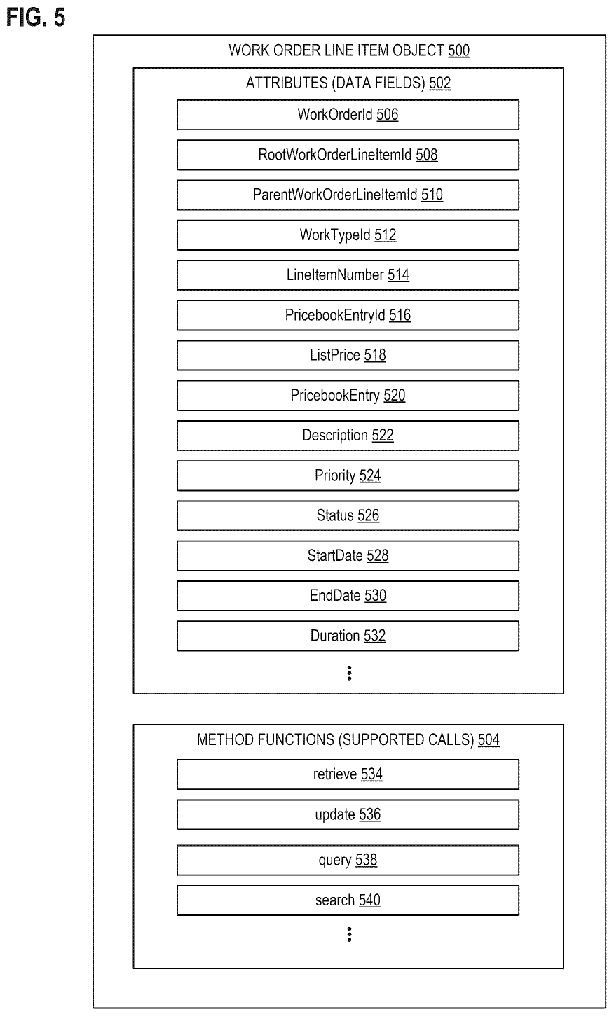

FIG. 5 illustrates an example work order line item object 500 that can represent a subtask on a work order in field service. The work order line item object 500 can be populated with a number of attributes (data fields) 502 and can also have associated with it a number of method functions (supported calls) 504 that can operate on the attributes 502. As illustrated, the attributes 502 of the example work order line item object 500 can include WorkOrderId 506, RootWorkOrderLineItemId 508, ParentWorkOrderLineItemId 510, WorkTypeId 512, LineItemNumber 514, PricebookEntryId 516, ListPrice 518, PricebookEntry 520, Description 522, Priority 524, Status 526, StartDate 528, EndDate 530, and Duration 532. In some examples, the work order line item object 500 can include one or more other attributes 502, such as Address, AssetId, Asset WarrantyId, City, Country, CurrencyIsoCode, Discount, DurationInMinutes, DurationType, Geocode Accuracy, IsClosed, IsGeneratedFromMaintenancePlan, LastReferencedDate, LastViewedDate, Latitude, LocationId, Longitude, MaintenancePlanId, Maintenance WorkRuleId, MinimumCrewSize, OrderId, PostalCode, Product2Id, ProductServiceCampaignId, ProductServiceCampaignItemId, RecommendedCrewSize, ReturnOrderId, ReturnOrderLineItemId, ServiceAppointmentCount, ServiceDocumentTemplate, ServiceReportTemplateId, ServiceTerritoryId, State, StatusCategory, Street, Subject, Subtotal, SuggestedMaintenanceDate, TotalPrice, and/or UnitPrice. As illustrated, the method functions 504 of the example work order line item object 500 can include retrieve 534, update 536, query 538, and search 540. In some examples, the work order line item object can include one or more other method functions 504, such as create, delete, describeLayout, describeSObjects, getDeleted, getUpdated, undelete, and/or upsert.

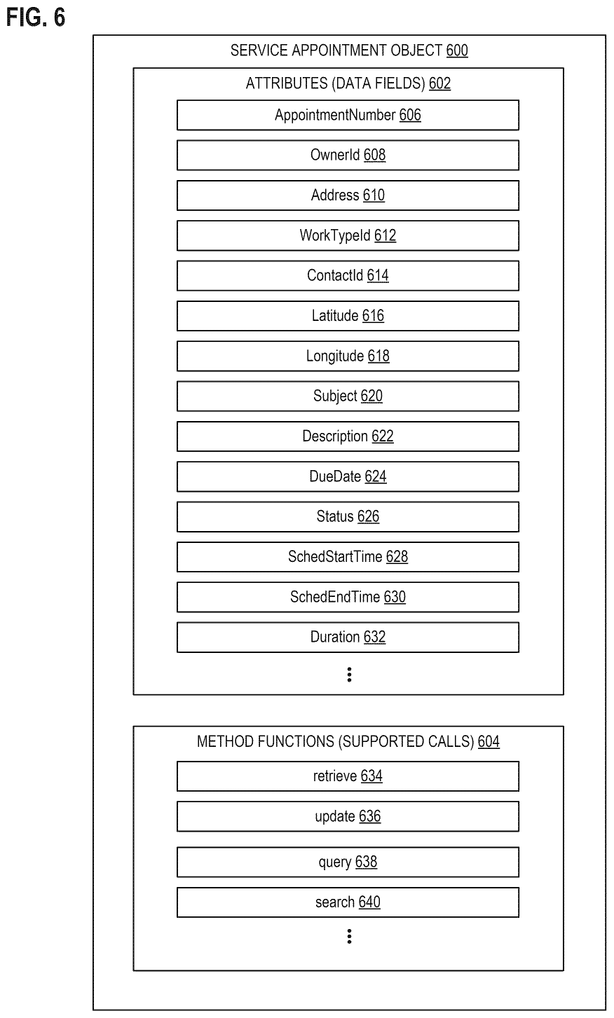

FIG. 6 illustrates an example service appointment object 600 that can represent an appointment to complete work for a customer in field service. The service appointment object 600 can be populated with a number of attributes (data fields) 602 and can also have associated with it a number of method functions (supported calls) 604 that can operate on the attributes 602. As illustrated, the attributes 602 of the example service appointment object 600 can include AppointmentNumber 606, OwnerId 608, Address 610, WorkTypeId 612, ContactId 614, Latitude 616, Longitude 618, Subject 620, Description 622, DueDate 624, Status 626, SchedStartTime 628, SchedEndTime 630, and Duration 632. In some examples, the service appointment object 600 can include one or more other attributes 602, such as AccountId, ActualDuration, ActualEndTime, ActualStartTime, ArrivalWindowEndTime, ArrivalWindowStartTime, BundlePolicyId, City, Country, DurationType, EarliestStartTime, GeocodeAccuracy, IsAnonymousBooking, IsBundle, IsBundleMember, IsManuallyBundled, IsOffsite Appointment, LastReferencedDate, LastViewedDate, ParentRecordId, ParentRecordStatusCategory, ParentRecordType, PostalCode, RelatedBundleId, ServiceDocumentTemplate, ServiceTerritoryId, State, StatusCategory, and/or Street. As illustrated, the method functions 604 of the example service appointment object 600 can include retrieve 634, update 636, query 638, and search 640. In some examples, the work order line item object can include one or more other method functions 604, such as create, delete, describeLayout, describeSObjects, getDeleted, getUpdated, undelete, and/or upsert.

### Prompt Template Builder

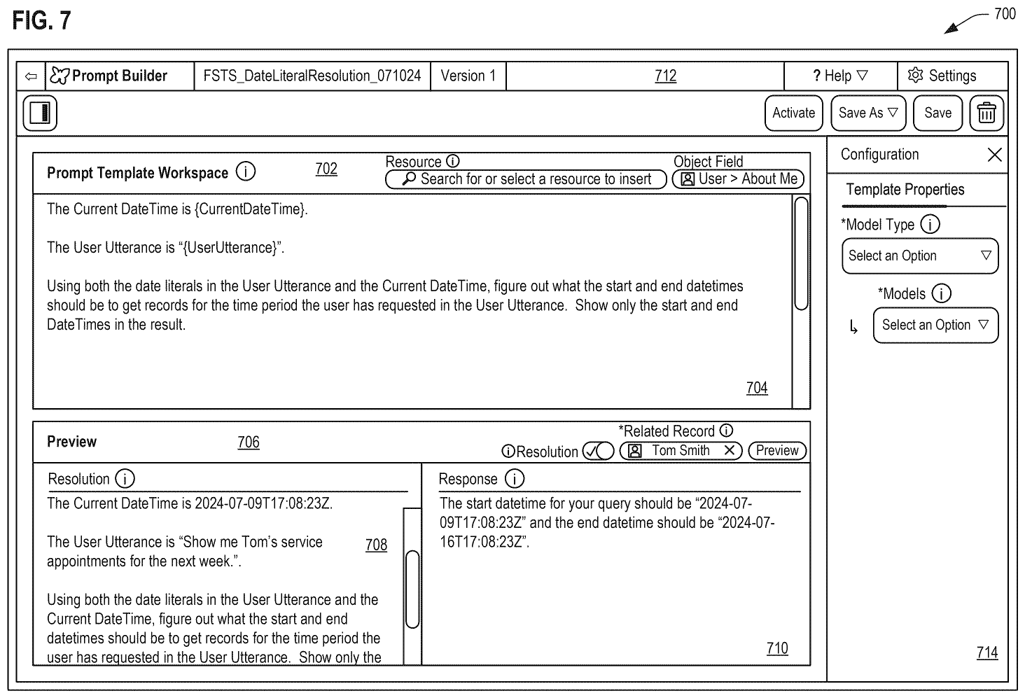

FIG. 7 illustrates an example generative AI input prompt template builder user interface 700 that can be used by a template drafting user (e.g., an administrator in a multi-tenant system) to write, verify, and save AI prompt templates. The template builder 700 can include a prompt template workspace 702 and a preview 706. The prompt template workspace 702 can include a text area field 704 where an AI prompt template can be drafted. The prompt template can include variable placeholders, sometimes referred to as merge fields, which in the illustrated example are denoted by being enclosed in matching opening and closing curly braces. For example, the illustrated AI prompt template shown in FIG. 7 includes a merge field for the current datetime and a merge field for the initial user utterance. The illustrated AI prompt template shown in field 704 in FIG. 7 includes instructions to a generative AI to determine start and end datetimes from the user utterance, using the current datetime for context. A prompt template such as the one shown in field 704 can be used, for example, by field service temporal service 334 in the system 300 of FIG. 3.

The preview 706 can include a resolution field 708 that shows an example prompt, that is, the prompt template as hydrated by substituting example data for the merge fields in the template. The resolution field 708 allows the drafting user to see what a template will look like when hydrated into a completed generative AI prompt. For example, the prompt template can be saved and stored to prompt template datastore 110 as shown in FIG. 1. The preview 706 can further include a response field 710 that displays the output of a selected generative AI given the prompt shown in the resolution field 708 as input. The template builder 700 can further include a title/menu bar 712 that can include a title and version number of the AI prompt template being worked on in the prompt builder 700, help and settings buttons, and buttons to activate/deactivate, save, and delete the template. The template builder 700 can further include a configuration pane 714 wherein one or more selections of a generative AI model type and a generative AI model can be made, via drop-down selection controls, for example.

### Field Service Data Record Search Methods

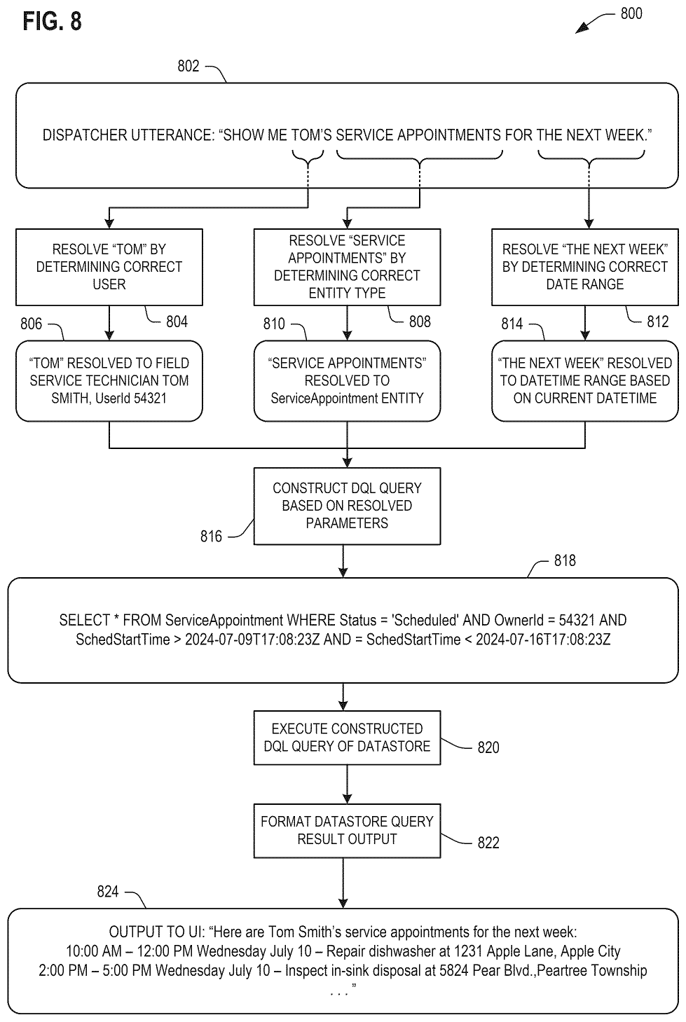

FIG. 8 illustrates an example method 800 of searching a datastore and returning relevant records based on a dispatcher utterance. As shown at 802, the dispatcher can provide an initial input utterance, e.g., to a UI of a user device, such as UI 104 of user device 102 in FIG. 1. For example, the utterance (or a textual transcription thereof) can be “Show me Tom's service appointments for the next week.”

In step 804, a field service data record query service 108 or system 300 can use generative AI and/or DQL query search methods, as described above, to resolve 804 a user name or portion thereof (“Tom” in the example utterance) to a correct user (e.g., to a user ID of the correct user). As shown at 806, in the illustrated example, “Tom” is resolved to field service technician Tom Smith having user ID 54321. As described above, resolution in step 804 can include a disambiguation process requesting and receiving disambiguation input from the user (not shown in FIG. 8).

In step 808, a field service data record query service 108 or system 300 can use generative AI and/or DQL query search methods, as described above, to resolve an entity type of the records desired to be searched (“service appointments” in the example utterance). As examples, the available entity types can include work orders, work order line items, and service appointments. As shown at 810, in the illustrated example, “service appointments” is resolved to the service appointment entity.

In step 812, a field service data record query service 108 or system 300 can use generative AI and/or DQL query search methods, as described above, to resolve a datetime range of the records desired to be searched (“the next week” in the example utterance) to specific numerical start and end datetimes, or to a datetime literal supported by a DQL. For example, the resolution can be based on the current datetime. As shown at 814, in the illustrated example, “the next week” is resolved to a start datetime of “2024-07-09T17:08:23Z” and to an end datetime of “2024-07-16T17:08:23Z”. The different method steps 804, 808, 812 can happen in any order, or can happen in parallel, in some examples.

In step 816, the method 800 can continue by constructing a DQL query based on the resolved parameters described above. As shown at 818 in the illustrated example, the constructed DQL query is “SELECT*FROM ServiceAppointment WHERE Status=‘Scheduled’ AND OwnerId=54321 AND SchedStartTime>2024-07-09T17:08:23Z AND=SchedStartTime<2024-07-16T17:08:23Z”.

In step 820, method 800 can continue by executing the constructed DQL query (e.g., as shown at 818) against a datastore, such as the work order and service appointment datastore 118 shown in FIG. 1, to produce a datastore query result output. In step 822, method 800 can further include formatting the datastore query result output. The formatted output can then be presented to the UI of the user device. As shown at 824, in the illustrated example, the formatted output includes at least the following text:
“Here are Tom Smith's service appointments for the next week:
10:00 AM-12:00 PM Wednesday July 10—Repair dishwasher at 1231 Apple Lane, Apple City 2:00 PM-5:00 PM Wednesday July 10—Inspect in-sink disposal at 5824 Pear Blvd., Peartree Township
. . . ”

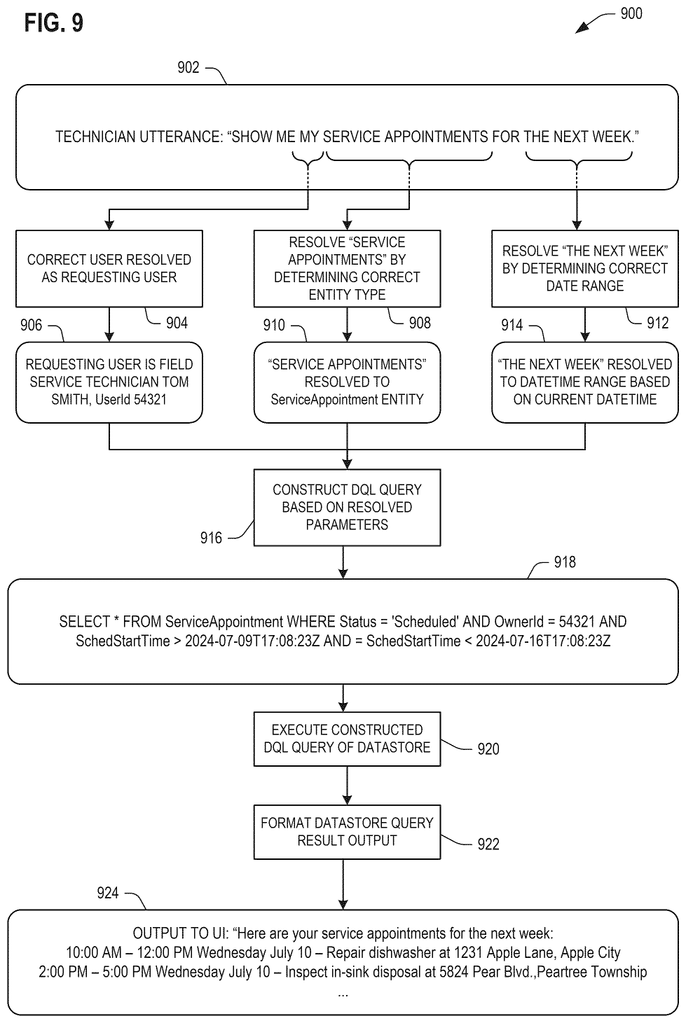

FIG. 9 illustrates an example method 900 of searching a datastore and returning relevant records based on a field service technician utterance. As shown at 902, the dispatcher can provide an initial input utterance, e.g., to a UI of a user device, such as UI 104 of user device 102 in FIG. 1. For example, the utterance (or a textual transcription thereof) can be “Show me my service appointments for the next week.”

In step 904, a field service data record query service 108 or system 300 can use generative AI and/or DQL query search methods, as described above, to resolve a correct user (e.g., a user ID of the correct user) as the requesting user. The field service data record query service 108 or system 300 can be configured to understand that a field service technician is permitted only to request field service records related to that same field service technician, and not those of other users. As shown at 906, in the illustrated example, the user is resolved to requesting field service technician Tom Smith having user ID 54321.

In step 908, a field service data record query service 108 or system 300 can use generative AI and/or DQL query search methods, as described above, to resolve an entity type of the records desired to be searched (“service appointments” in the example utterance). As examples, the available entity types can include work orders, work order line items, and service appointments. As shown at 910, in the illustrated example, “service appointments” is resolved to the service appointment entity.

In step 912, a field service data record query service 108 or system 300 can use generative AI and/or DQL query search methods, as described above, to resolve a datetime range of the records desired to be searched (“the next week” in the example utterance) to specific numerical start and end datetimes, or to a datetime literal supported by a DQL. For example, the resolution can be based on the current datetime. As shown at 914, in the illustrated example, “the next week” is resolved to a start datetime of “2024-07-09T17:08:23Z” and to an end datetime of “2024-07-16T17:08:23Z”. The different method steps 904, 908, 912 can happen in any order, or can happen in parallel, in some examples.

In step 916, the method 900 can continue by constructing a DQL query based on the resolved parameters described above. As shown at 918, in the illustrated example, the DQL query is “SELECT*FROM ServiceAppointment WHERE Status=‘Scheduled’ AND OwnerId=54321 AND SchedStartTime>2024-07-09T17:08:23Z AND=SchedStartTime<2024-07-16T17:08:23Z”.

In step 920, method 900 can continue by executing the constructed DQL query (e.g., as shown at 918) against a datastore, such as the work order and service appointment datastore 118 shown in FIG. 1, to produce a datastore query result output. In step 922, method 900 can further include formatting the datastore query result output. The formatted output can then be presented to the UI of the user device. As shown at 924, in the illustrated example, the formatted output includes at least the following text:
“Here are your service appointments for the next week:
10:00 AM-12:00 PM Wednesday July 10—Repair dishwasher at 1231 Apple Lane, Apple City 2:00 PM-5:00 PM Wednesday July 10—Inspect in-sink disposal at 5824 Pear Blvd., Peartree Township
. . . ”

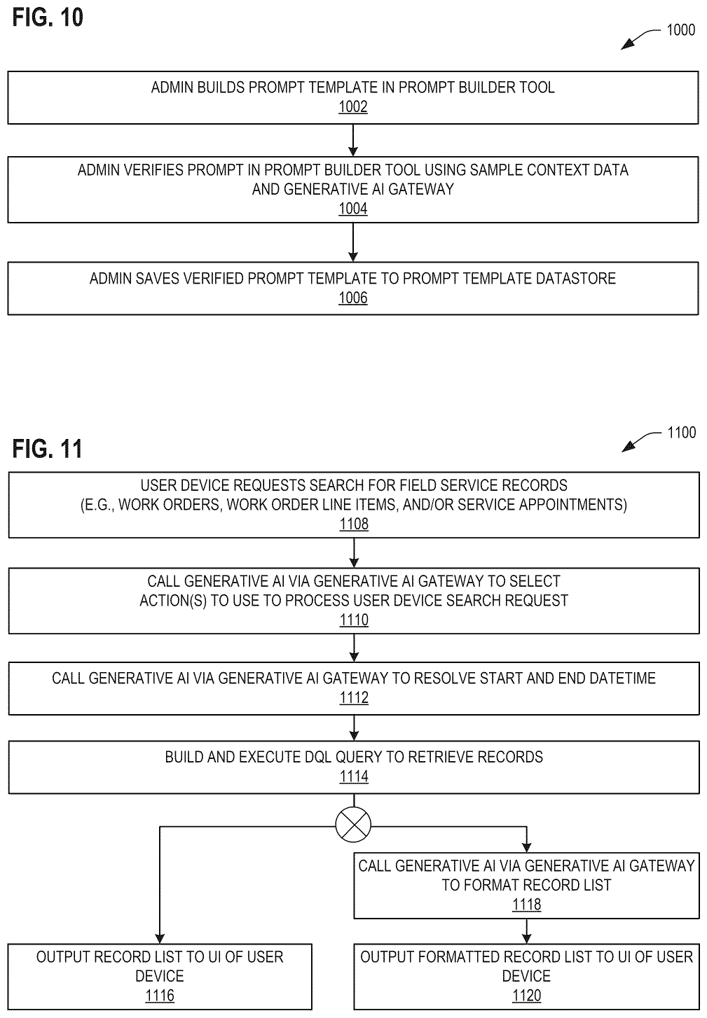

FIG. 10 illustrates an example method 1000 of building, verifying, and saving a generative AI input prompt template. In step 10002, an administrator, e.g., an administrator of an organization in a multi-tenant system, can build a prompt template using a prompt builder tool, e.g., prompt builder 700 as described above with reference to FIG. 7. In step 1004, the administrator can verify the prompt in the prompt builder tool using sample context data and a generative AI gateway, e.g., generative AI gateway 308 described above with regard to FIG. 3. In step 1006, the administrator can then save the verified prompt template to a prompt template datastore, e.g., prompt template datastore 110 described above with regard to FIG. 1. The saved prompt template can then be called upon by implementations described herein, e.g., by field service data record query service 108 or 200, prompt template fetcher 208, prompt generator 210, Copilot Planner 304, Field Service Query Record Copilot action 322, field service temporal service 334, and/or generative AI gateway 308.

FIG. 11 is a flow diagram of an example method 1100 of field service record search using generative AI. In step 1108 of method 1100, a user device requests a search for field service records, such as work orders, work order line items, and/or service appointments. The request can be made, for example, to a field service data record query service 108 or system 300, as described above. The request can, for example, comprise a natural-language user utterance. The user device can, for example, be user device 102 in FIG. 1.

In step 1110, the method can continue by calling a generative AI via a generative AI gateway to select one or more actions to use to process the user device search request. The generative AI can be, for example, generative AI 124 in FIG. 1. The generative AI gateway can be, as examples, generative AI gateway 212 in FIG. 2 or generative AI gateway 308 in FIG. 3. The selected one or more actions can include, for example, Field Service Query Record Copilot action 322 described above with regard to FIG. 3. Where more than one action is selected by the generative AI, or where the selection of one action by the generative AI calls for other actions to also be performed, the multiple actions can be chained together in a plan.

In step 1112, the method 1100 can continue by calling a generative AI via a generative AI gateway to resolve a start and end datetime. The resolution can be as described above, and can be based on a prompt that can include the initial user utterance in the user device request and the current datetime as context data.

In step 1114, the method 1100 can continue by building and executing a DQL query (e.g., a SQL query) to retrieve records relevant to the user device request, which query execution results in a record list. The DQL query can be based on the selected one or more actions and the resolved start and end datetime.

In step 1116, the method can continue by outputting the result list to a UI of a user device, e.g., UI 104 of user device 102 in FIG. 1. Alternatively, in step 1118, the method 1100 can continue by calling a generative AI via a generative AI gateway to format the record list, then, in step 1120, outputting the formatted record list to the UI of the user device.

### Electronic Device and Machine-Readable Media

One or more parts of the above implementations may include software. Software is a general term the meaning of which can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals-such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

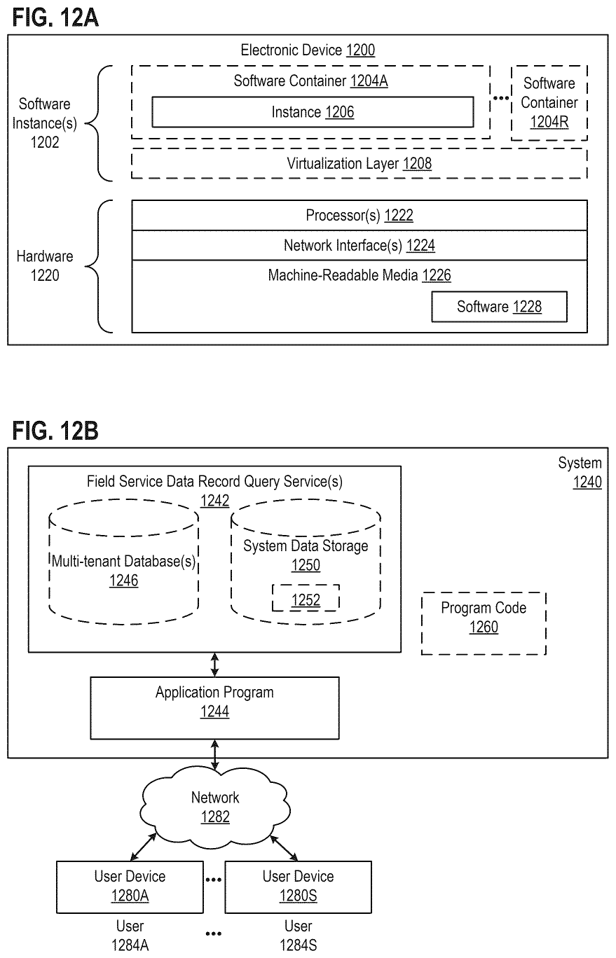

FIG. 12A is a block diagram illustrating an electronic device 1200 according to some example implementations. FIG. 12A includes hardware 1220 comprising a set of one or more processor(s) 1222, a set of one or more network interfaces 1224 (wireless and/or wired), and machine-readable media 1226 having stored therein software 1228 (which includes instructions executable by the set of one or more processor(s) 1222). The machine-readable media 1226 may include non-transitory and/or transitory machine-readable media. Each of the previously described clients and the field service data record query service 108, 200 or system 300 may be implemented in one or more electronic devices 1200. In one implementation: 1) each of the clients is implemented in a separate one of the electronic devices 1200 (e.g., in end user devices where the software 1228 represents the software to implement clients to interface directly and/or indirectly with the field service data record query service (e.g., software 1228 represents a web browser, a native client, a portal, a command-line interface, and/or an application programming interface (API) based upon protocols such as Simple Object Access Protocol (SOAP), Representational State Transfer (REST), etc.)); 2) the field service data record query service is implemented in a separate set of one or more of the electronic devices 1200 (e.g., a set of one or more server devices where the software 1228 represents the software to implement the field service data record query service); and 3) in operation, the electronic devices implementing the clients and the field service data record query service would be communicatively coupled (e.g., by a network) and would establish between them (or through one or more other layers and/or or other services) connections for submitting an initial user utterance and, in some instances, one or more follow-up user utterances to the field service data record query service 108, 200 or system 300 and returning field service records to the clients. Other configurations of electronic devices may be used in other implementations (e.g., an implementation in which the client and the field service data record query service are implemented on a single one of electronic device 1200).

During operation, an instance of the software 1228 (illustrated as instance 1206 and referred to as a software instance; and in the more specific case of an application, as an application instance) is executed. In electronic devices that use compute virtualization, the set of one or more processor(s) 1222 typically execute software to instantiate a virtualization layer 1208 and one or more software container(s) 1204A-1204R (e.g., with operating system-level virtualization, the virtualization layer 1208 may represent a container engine (such as Docker Engine by Docker, Inc. or rkt in Container Linux by Red Hat, Inc.) running on top of (or integrated into) an operating system, and it allows for the creation of multiple software containers 1204A-1204R (representing separate user space instances and also called virtualization engines, virtual private servers, or jails) that may each be used to execute a set of one or more applications; with full virtualization, the virtualization layer 1208 represents a hypervisor (sometimes referred to as a virtual machine monitor (VMM)) or a hypervisor executing on top of a host operating system, and the software containers 1204A-1204R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 1228 is executed within the software container 1204A on the virtualization layer 1208. In electronic devices where compute virtualization is not used, the instance 1206 on top of a host operating system is executed on the “bare metal” electronic device 1200. The instantiation of the instance 1206, as well as the virtualization layer 1208 and software containers 1204A-1204R if implemented, are collectively referred to as software instance(s) 1202.

Alternative implementations of an electronic device may have numerous variations from that described above. For example, customized hardware and/or accelerators might also be used in an electronic device.

### Example Environment

FIG. 12B is a block diagram of a deployment environment according to some example implementations. A system 1240 includes hardware (e.g., a set of one or more server devices) and software to provide service(s) 1242, including the field service data record query service 1242, which can correspond to field service data record query service 108 or 200 or system 300 described above. In some implementations, the system 1240 is in one or more datacenter(s). These datacenter(s) may be: 1) first party datacenter(s), which are datacenter(s) owned and/or operated by the same entity that provides and/or operates some or all of the software that provides the service(s) 1242; and/or 2) third-party datacenter(s), which are datacenter(s) owned and/or operated by one or more different entities than the entity that provides the service(s) 1242 (e.g., the different entities may host some or all of the software provided and/or operated by the entity that provides the service(s) 1242). For example, third-party datacenters may be owned and/or operated by entities providing public cloud services (e.g., Amazon.com, Inc. (Amazon Web Services), Google LLC (Google Cloud Platform), Microsoft Corporation (Azure)).

The system 1240 is coupled to user devices 1280A-1280S over a network 1282. The service(s) 1242 may be on-demand services that are made available to one or more of the users 1284A-1284S working for one or more entities other than the entity which owns and/or operates the on-demand services (those users sometimes referred to as outside users) so that those entities need not be concerned with building and/or maintaining a system, but instead may make use of the service(s) 1242 when needed (e.g., when needed by the users 1284A-1284S). The service(s) 1242 may communicate with each other and/or with one or more of the user devices 1280A-1280S via one or more APIs (e.g., a REST API). In some implementations, the user devices 1280A-1280S are operated by users 1284A-1284S, and each may be operated as a client device and/or a server device. In some implementations, one or more of the user devices 1280A-1280S are separate ones of the electronic device 1200 or include one or more features of the electronic device 1200.

In some implementations, the system 1240 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 1240 is a multi-tenant cloud computing architecture supporting multiple services, such as one or more of the following types of services: Field service data record query service 1242, Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Security; and Identity and access management (IAM). For example, system 1240 may include an application platform 1244 that enables PAAS for creating, managing, and executing one or more applications developed by the provider of the application platform 1244, users accessing the system 1240 via one or more of user devices 1280A-1280S, or third-party application developers accessing the system 1240 via one or more of user devices 1280A-1280S.

In some implementations, one or more of the service(s) 1242 may use one or more multi-tenant databases 1246, as well as system data storage 1250 for system data 1252 accessible to system 1240. In certain implementations, the system 1240 includes a set of one or more servers that are running on server electronic devices and that are configured to handle requests for any authorized user associated with any tenant (there is no server affinity for a user and/or tenant to a specific server). The user devices 1280A-1280S communicate with the server(s) of system 1240 to request and update tenant-level data and system-level data hosted by system 1240, and in response the system 1240 (e.g., one or more servers in system 1240) automatically may generate one or more DQL statements, such as one or more SQL statements (e.g., one or more SQL queries) or one or more SOQL statements, that are designed to access the desired information from the multi-tenant database(s) 1246 and/or system data storage 1250.

In some implementations, the service(s) 1242 are implemented using virtual applications dynamically created at run time responsive to queries from the user devices 1280A-1280S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 1260 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 1244 includes an application setup mechanism that supports application developers' creation and management of applications, which may be saved as metadata by save routines. Invocations to such applications, including the field service data record query service, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 1282 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4th generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 1240 and the user devices 1280A-1280S.

Each user device 1280A-1280S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 1240. For example, the user interface device can be used to access data and applications hosted by system 1240, and to perform searches on stored data, and otherwise allow one or more of users 1284A-1284S to interact with various GUI pages that may be presented to the one or more of users 1284A-1284S. User devices 1280A-1280S might communicate with system 1240 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 1280A-1280S might include an HTTP client, commonly referred to as a “browser,” for sending and receiving HTTP messages to and from server(s) of system 1240, thus allowing users 1284A-1284S of the user devices 1280A-1280S to access, process and view information, pages and applications available to it from system 1240 over network 1282.

### CONCLUSION

In the above description, numerous specific details such as resource partitioning/sharing/duplication implementations, types and interrelationships of system components, and logic partitioning/integration choices are set forth in order to provide a more thorough understanding. Implementations may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

1. A non-transitory machine-readable storage medium that provides instructions that, if executed by a set of one or more processors, are configurable to cause said set of one or more processors to perform operations comprising:
generating a first generative artificial intelligence (AI) prompt based on an utterance requesting a search of records stored in one or more record datastores, wherein the first generative AI prompt includes instructions to select one or more actions with which to process the utterance;
transmitting the first generative AI prompt to a generative AI via a generative AI gateway to select, based on the utterance, the one or more actions with which to process the utterance, wherein the one or more actions are selected from among a plurality of actions that are listed in actions metadata transmitted along with or as part of the first generative AI prompt, or that are known to the generative AI based on training of the generative AI;
generating a second generative AI prompt based on the utterance and the current datetime;
transmitting the second generative AI prompt to the generative AI via the generative AI gateway to resolve a start datetime and an end datetime based on the utterance and the current datetime;
building a record data query language (DQL) query based on the selected one or more actions, the start datetime, and the end datetime;
executing the record DQL query on at least one of the one or more record datastores to receive a list of records; and
transmitting the list of records responsive to the utterance.

2. The machine-readable storage medium of claim 1, wherein the operations further comprise, before the transmitting the list of records:
generating a third generative AI prompt based on the utterance and the list of records; and
transmitting the third generative AI prompt to the generative AI via the generative AI gateway to format the list of records for display, wherein the formatting comprises arranging and tabularizing information in the list of records.

3. The machine-readable storage medium of claim 1, wherein the building the record DQL query comprises:
selecting a record DQL query prompt template from a plurality of record DQL query prompt templates; and
replacing placeholders in the selected record DQL query prompt template to hydrate the selected record DQL query prompt template with a field search record entity type, the start datetime, and the end datetime, wherein the field search record entity type is based on the selected one or more actions.

4. The machine-readable storage medium of claim 1, wherein the operations further comprise, before the generating the first generative AI prompt:
receiving, from a user device, a message comprising the utterance and a user identifier (ID) of a requesting user authenticated to the user device; and
determining, based on the user ID of the requesting user, that the requesting user is of a technician user type;
and wherein the building of the record DQL query is further based on the user ID of the requesting user.

5. The machine-readable storage medium of claim 1, wherein the records are field service records, wherein the one or more record datastores are one or more field service record datastores, and wherein the operations further comprise:
receiving, from a user device, a message comprising the utterance and a user identifier (ID) of a requesting user authenticated to the user device, wherein the transmitting the first generative AI prompt to select the one or more actions returns a full or partial user name extracted from the utterance;
determining, based on the user ID of the requesting user, that the requesting user is of a dispatcher user type or an administrator user type;
building a user record DQL query based on the full or partial user name; and
executing the user record DQL query on a user record datastore to return one or more user records, each user record comprising a corresponding user ID,
wherein the building of the record DQL query is further based on a corresponding user ID of the one of the one or more user records.

6. The machine-readable storage medium of claim 5, wherein the operations further comprise, before the building the record DQL query:
determining that the returned one or more user records comprise more than one user record;
transmitting a request for user record disambiguation to the user device, the request for user record disambiguation comprising at least a portion of the one or more user records; and
receiving a disambiguating response from the user device, the disambiguating response selecting a particular user record of the one or more user records,
wherein the building of the record DQL query is based on a corresponding user ID of the particular user record.

7. The machine-readable storage medium of claim 1, wherein the records comprise field service work order records, field service work order line item records, and field service appointment records.

8. The machine-readable storage medium of claim 1, wherein the generating the first generative AI prompt comprises:
selecting an AI prompt template from a prompt template datastore, the prompt template comprising instructions to select the one or more actions with which to process the utterance from among a set of available actions, wherein the selecting is based on the utterance; and
building the first generative AI prompt based on the selected AI prompt template, wherein the building comprises replacing a placeholder in the selected AI prompt template to hydrate the AI prompt template with the utterance.

9. The machine-readable storage medium of claim 8, wherein the set of available actions are provided to the generative AI along with or as part of the AI prompt as the actions metadata comprising a list of a plurality of names of the available actions and corresponding natural-language textual descriptions of the available actions.

10. A computer-implemented method comprising:
generating, by one or more computing devices, a first generative artificial intelligence (AI) prompt based on an utterance requesting a search of records stored in one or more record datastores, wherein the first generative AI prompt includes instructions to select one or more actions with which to process the utterance;
transmitting, by the one or more computing devices, the first generative AI prompt to a generative AI via a generative AI gateway to select, based on the utterance, the one or more actions with which to process the utterance, wherein the one or more actions are selected from among a plurality of actions that are listed in actions metadata transmitted along with or as part of the first generative AI prompt, or that are known to the generative AI based on training of the generative AI;
generating, by the one or more computing devices, a second generative AI prompt based on the utterance and the current datetime;
transmitting, by the one or more computing devices, the second generative AI prompt to the generative AI via the generative AI gateway to resolve a start datetime and an end datetime based on the utterance and the current datetime;
building, by the one or more computing devices, a record data query language (DQL) query based on the selected one or more actions, the start datetime, and the end datetime;
executing, by the one or more computing devices, the DQL query on at least one of the one or more record datastores to receive a list of records; and
transmitting, by the one or more computing devices, the list of records responsive to the utterance.

11. The computer-implemented method of claim 10, further comprising, before the transmitting the list of records:
generating, by the one or more computing devices, a third generative AI prompt based on the utterance and the list of records; and
transmitting, by the one or more computing devices, the third generative AI prompt to the generative AI via the generative AI gateway to format the list of records for display, wherein the formatting comprises arranging and tabularizing information in the list of records.

12. The computer-implemented method of claim 10, wherein the building the record DQL query comprises:
selecting, by the one or more computing devices, a record DQL query prompt template from a plurality of record DQL query prompt templates; and
replacing placeholders, by the one or more computing devices, in the selected record DQL query prompt template to hydrate the selected record DQL query prompt template with a field search record entity type, the start datetime, and the end datetime, wherein the field search record entity type is based on the selected one or more actions.

13. The computer-implemented method of claim 10, further comprising:
receiving, by the one or more computing devices, from a user device, a message comprising the utterance and a user identifier (ID) of a requesting user authenticated to the user device; and
determining, by the one or more computing devices, based on the user ID of the requesting user, that the requesting user is of a technician user type;
and wherein the building of the record DQL query is further based on the user ID of the requesting user.

14. The computer-implemented method of claim 10, wherein the records are field service records, wherein the one or more record datastores are one or more field service record datastores, and wherein the method further comprises:
receiving, by the one or more computing devices, from a user device, a message comprising the utterance and a user identifier (ID) of a requesting user authenticated to the user device, wherein the transmitting the first generative AI prompt to select the one or more actions returns a full or partial user name extracted from the utterance;
determining, by the one or more computing devices, based on the user ID of the requesting user, that the requesting user is of a dispatcher user type or an administrator user type;
building, by the one or more computing devices, a user record DQL query based on the full or partial user name; and
executing, by the one or more computing devices, the user record DQL query on a user record datastore to return one or more user records, each user record comprising a corresponding user ID,
wherein the building of the record DQL query is further based on a corresponding user ID of the one of the one or more user records.

15. The computer-implemented method of claim 14, further comprising, before the building the record DQL query:
determining, by the one or more computing devices, that the returned one or more user records comprise more than one user record;
transmitting, by the one or more computing devices, a request for user record disambiguation to the user device, the request for user record disambiguation comprising at least a portion of the one or more user records; and
receiving, by the one or more computing devices, a disambiguating response from the user device, the disambiguating response selecting a particular user record of the one or more user records,
wherein the building of the record DQL query is based on a corresponding user ID of the particular user record.

16. The computer-implemented method of claim 10, wherein the records comprise field service work order records, field service work order line item records, and field service appointment records.

17. The computer-implemented method of claim 10, wherein the generating the first generative AI prompt comprises:
selecting, by the one or more computing devices, an AI prompt template from a prompt template datastore, the prompt template comprising instructions to select the one or more actions with which to process the utterance from among a set of available actions, wherein the selecting is based on the utterance; and
building, by the one or more computing devices, the first generative AI prompt based on the selected AI prompt template, wherein the building comprises replacing a placeholder in the selected AI prompt template to hydrate the AI prompt template with the utterance.

18. The computer-implemented method of claim 17, wherein the set of available actions are provided to the generative AI along with or as part of the AI prompt as the actions metadata comprising a list of a plurality of names of the available actions and corresponding natural-language textual descriptions of the available actions.

19. The computer-implemented method of claim 10, wherein the generating the second generative AI prompt comprises:
selecting an AI prompt template from a prompt template datastore, the prompt template comprising instructions to determine the start datetime and end datetime based on the utterance; and
building the second generative AI prompt based on the selected AI prompt template, wherein the building comprises replacing placeholders in the selected AI prompt template to hydrate the AI prompt template with the current datetime and the utterance.

20. An apparatus comprising:
a set of one or more processors;
a non-transitory machine-readable storage medium that provides instructions that, if executed by the set of one or more processors, are configurable to cause the apparatus to perform operations comprising:
generating a first generative artificial intelligence (AI) prompt based on an utterance requesting a search of records stored in one or more record datastores, wherein the first generative AI prompt includes instructions to select one or more actions with which to process the utterance;
transmitting the first generative AI prompt to a generative AI via a generative AI gateway to select, based on the utterance, the one or more actions with which to process the utterance, wherein the one or more actions are selected from among a plurality of actions that are listed in actions metadata transmitted along with or as part of the first generative AI prompt, or that are known to the generative AI based on training of the generative AI;
generating a second generative AI prompt based on the utterance and the current datetime;
transmitting the second generative AI prompt to the generative AI via the generative AI gateway to resolve a start datetime and an end datetime based on the utterance and the current datetime;
building a record data query language (DQL) query based on the selected one or more actions, the start datetime, and the end datetime;
executing the record DQL query on at least one of the one or more record datastores to receive a list of records; and
transmitting the list of records responsive to the utterance.
